(19) United States
(12) Patent Application Publication
(10) Pub. No.: US 2016/0302407 A1
(43) Pub. Date: Oct. 20, 2016

(54) SULFONYLUREA HERBICIDE-CONTAINING SUBSTRATES AND METHODS OF MAKING THE SAME

(71) Applicant: OMS INVESTMENTS, INC, Los Angeles, CA (US)

(72) Inventors: Patrick MWONYA, Pendleton, IN (US); Marcus BERTIN, Dublin, OH (US); Robert M.A. RADABAUGH, Columbus, OH (US); Johnathon Clark Raistlin NEWTON, Columbus, OH (US)

(21) Appl. No.: 15/103,208

(22) PCT Filed: Dec. 9, 2014
(86) PCT No.: PCT/US14/69361

§ 371 Date: Jun. 9, 2016

Related U.S. Application Data
(60) Provisional application No. 61/913,807, filed on Dec. 9, 2013.

(51) Int. Cl. A01N 25/22; A01N 47/36

(52) U.S. Cl. CPC A01N 25/22; A01N 47/36

(57) ABSTRACT

Compositions comprising a substrate coated with a sulfonylurea herbicide, and methods for making and using such compositions, are generally described herein.

### FIELD OF INVENTION

Granular compositions including sulfonylurea herbicides and carrier herein, and methods of manufacture and use thereof are generally described herein.

### BACKGROUND OF INVENTION

An herbicide is useful for killing unwanted plants. For consumer use, it is desirable that the herbicide remain stable for long periods of time, so that it remains viable when used by the consumer.

Sulfonylurea herbicides, including but not limited to metsulfuron-methyl and other triazinylsulfonylurea herbicides, as well as pyrimidinylsulfonylurea herbides, can be used for killing weeds, including dollar weeds and clovers. A known problem with sulfonylurea herbicides is the tendency to degrade in certain environments. In particular, the sulfonylurea compound has a labile sulfonamide bridge susceptible to hydrolysis in the presence of water.

The propensity to degrade can affect the ability of a consumer to use the herbicide. For example, metsulfuron-methyl is typically applied by professionals who must create an aqueous suspension, and apply the suspension within a short time frame (e.g., typically within four hours from developing the suspension). This prevents loss of the herbicide due to degradation prior to application.

### SUMMARY OF EMBODIMENTS OF THE INVENTION

Among other things, compositions comprising a substrate and a sulfonylurea herbicide that remain stable over time are provided.

It is an object of some embodiments to provide compositions comprising a substrate, a sulfonylurea herbicide and a carrier (e.g., a solvent), for safe and effective herbicidal treatment of unwanted weeds.

It is an object of some embodiments to provide a composition comprising a substrate, a sulfonylurea herbicide, and a carrier (e.g., a solvent), that both promotes growth of desired plants and kills unwanted plants.

It is an object of some embodiments to provide methods of making herbicidal compositions in which the sulfonylurea herbicide is suspended as a liquid suspension with a carrier (e.g., a solvent). The liquid suspension may then be applied to or coated onto a substrate (e.g., via spraying, dipping, etc.).

It is an object of some embodiments to provide methods of making herbicidal compositions in which the sulfonylurea herbicide is tacked onto a substrate (e.g., a granular fertilizer and/or a stabilizing compound) by combining the sulfonylurea herbicide with a carrier (e.g., a tackifier) to create a tackable compound, and then tacking the tackable compound onto the substrate.

In any of the above objects, the substrate may include a stabilizing compound, fertilizer, and/or a water-absorbent compound.

It is an object of some embodiments to provide compositions comprising a substrate, a sulfonylurea herbicide, and a carrier that remain stable for a period of at least six months when, for example, are stored in a bag or container.

It is an object of some embodiments to provide a lawn to which has been applied the compositions of any of the embodiments described herein.

The foregoing and other objects are achieved by providing a granular herbicidal composition comprising a sulfonylurea herbicide and a carrier (e.g., a solvent or tackifier) coated onto or impregnated into a solid granular substrate material.

### DETAILED DESCRIPTION OF PREFERRED EMBODIMENTS OF THE INVENTION

Herbicidal compositions are provided. These compositions generally include a substrate, at least one sulfonylurea herbicide, and a carrier (e.g., a solvent or tackifier). These compositions are surprisingly stable when stored for extended periods of time. Moreover, these compositions are effective at controlling weeds after extended storage. As a result, the herbicidal compositions described herein are advantageous for consumer use.

In some embodiments, the substrate includes a stabilizing compound, fertilizer, or both a stabilizing compound and fertilizer. A water-absorbent compound may also be included within or coated onto the substrate. The sulfonylurea herbicide and carrier (e.g., a solvent or tackifier) may be applied to the composition as a liquid suspension or as a tackable compound.

### BRIEF DESCRIPTION OF FIGURES

FIGS. 1A-1C show the stability of 1.23% metsulfuron-methyl suspended in polybutene when stored at room temperature (FIG. 1A), 35° C. (FIG. 1B), and 50° C. (FIG. 1C) over eight weeks.

FIGS. 2A-2C show the stability of about 3.17% metsulfuron-methyl suspended in polybutene when stored at room temperature (FIG. 2A), 35° C. (FIG. 2B), and 50° C. (FIG. 2C) over eight weeks.

FIGS. 3A-3C show the stability of 4.42% metsulfuron-methyl suspended in polybutene when stored at room temperature (FIG. 3A), 35° C. (FIG. 3B), and 50° C. (FIG. 3C) over eight weeks.

FIGS. 4A and 4B show the stability of a composition comprising fertilizer, metsulfuron-methyl, and polybutene stored at 50° C. over a period of twelve weeks. FIG. 4A demonstrates the stability of the composition at 50° C. FIG. 4B is a graphical representation of the stability data of FIG. 4A.

FIGS. 5A and 5B show the stability of a composition comprising fertilizer, metsulfuron-methyl, and BIODAC® stored at 50° C. over a period of eight weeks. FIG. 5A demonstrates the stability of the composition at 50° C. FIG. 5B is a graphical representation of the stability data of FIG. 5A.

FIGS. 6A and 6B shows the stability of a composition comprising fertilizer, metsulfuron-methyl, and BIODAC® stored at 50° C. over a period of five weeks. FIG. 6A demonstrates the stability of the composition at 50° C. FIG. 6B is a graphical representation of the stability data of FIG. 6A.

FIGS. 7A and 7B show the stability of a composition comprising fertilizer, metsulfuron-methyl, and polybutene stored at 50° C. over a period of eight weeks. FIG. 7A demonstrates the stability of the composition at 50° C. FIG. 7B is a graphical representation of the stability data of FIG. 7A.

FIGS. 8A and 8B show the stability of a composition comprising fertilizer, metsulfuron-methyl, polybutene, and MgSO₄ stored at 50° C. over a period of eight weeks. FIG. 8A demonstrates the stability of the composition at 50° C. FIG. 8B is a graphical representation of the stability data of FIG. 8A.

FIG. 9 shows the stability of a composition comprising fertilizer, metsulfuron-methyl, BIODAC®, MgSO₄, and polybutene stored at 50° C. over a period of eight weeks.

FIG. 10 shows the stability of a composition comprising fertilizer, metsulfuron-methyl, BIODAC®, MgSO₄, and polybutene stored at 50° C. over a period of eight weeks.

FIG. 11 shows the stability of a composition comprising fertilizer, metsulfuron-methyl, BIODAC®, MgSO₄, and polybutene stored at 40° C. over a period of twelve weeks.

FIG. 12 shows the stability of a composition comprising fertilizer, metsulfuron-methyl, BIODAC®, MgSO₄, and polybutene stored at 35° C. over a period of sixteen weeks.

FIG. 13 shows the stability of a composition comprising fertilizer, metsulfuron-methyl, BIODAC®, MgSO₄, and polybutene stored at room temperature over a period of fifty-two weeks.

### SUBSTRATE

Herbicidal compositions comprising a substrate, sulfonylurea herbicide, and a carrier are described herein. The sulfonylurea herbicide and carrier (e.g., a solvent or tackifier) may be coated or tacked onto the substrate, or impregnated within the substrate. Suitable substrates include any agricultural substance in which a coating is desired to be applied thereon. For example, the substrate may be and/or include a stabilizing compound and/or a fertilizer. The substrate may also include a water-absorbent compound.

In some embodiments, the substrate has a neutral or alkaline pH. For example, in some embodiments, the pH of the substrate is at least 7.0, at least 7.5, at least 8.0, at least 8.5, at least 9.0, at least 9.5, or at least 10.0. This is desirable since sulfonylurea herbicides, such as metsulfuron-methyl, degrade in acidic conditions.

In some embodiments, the substrate has a low moisture level. The substrate may naturally possess a low moisture level or can be dried to achieve a low moisture level. For example, the substrate may have or be dried to a moisture level of less than 2% moisture, less than 1.75% moisture, less than 1.5% moisture, less than 1.25% moisture, or less than 1.00% moisture. This is desirable since sulfonylurea herbicides, such as metsulfuron-methyl, degrade in high-moisture conditions.

In some embodiments, the substrate has a pH of at least 7.0, at least 7.5, at least 8.0, at least 8.5, at least 9.0, at least 9.5, or at least 10.0, and a moisture level of less than 2% moisture, less than 1.75% moisture, less than 1.5% moisture, less than 1.25% moisture, or less than 1.00% moisture.

In any of the embodiments, the substrate is agronomically beneficial or not agronomically detrimental.

### Stabilizing Compound

In one embodiment, the substrate comprises a stabilizing compound. A stabilizing compound may include any material that has a pH of at least 7.0, at least 7.5, at least 8.0, at least 8.5, at least 9.0, at least 9.5, or at least 10.0, and/or a liquid holding capacity of at least 10%, at least 15%, at least 20%, at least 25%, at least 30%, at least 35%, or at least 40%. Stabilizing compounds include, but are not limited to, cellulose fibers, dolomite, limestone, gypsum, corncobs, peanut hulls, processed paper pulp, sawdust, sand, vermiculite, perlite, fuller's earth, diatomaceous earth, and clays such as attapulgite clays, bentonite clays, montmorillonite clays, ECOGRANULE® (a granular carrier with a wood fiber core), DG LITE® (a granular carrier comprising limestone), or any combinations thereof. In one embodiment, the stabilizing compound is a commercially available cellulose fiber such as BIODAC® (Kadant GranTek, Inc.), described in U.S. Pat. No. 5,843,203, which is hereby incorporated by reference. In any of the embodiments, the stabilizing compound is agronomically beneficial or not agronomically detrimental.

In any of the embodiments described herein, the stabilizing compound may comprise a salt, including but not limited to, Na₂CO₃, NaHCO₃, Na₃PO₄, Na₂HPO₄, K₂HPO₄, K₂SO₄, and the like, and mixtures thereof.

In some embodiments, the compositions include a stabilizing compound of 1-95% by weight of the composition. The stabilizing compound may comprise at least 1%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95% by weight of the composition.

The stabilizing compound may also function as a pH adjuster, for example, raising the pH of the composition into a desired range (e.g., pH of 7.0-10.0). The stabilizing compound may also reduce the moisture of the composition, due to its ability to retain water and remove it from reacting with other components, such as the sulfonylurea herbicide.

### Fertilizers

In some embodiments, the substrate comprises a fertilizer. A wide variety of fertilizer granules, particles, extruded particles, or pellets (referred to collectively herein as “fertilizer granules”) such as organic and inorganic nitrogen-containing compounds include urea, urea-formaldehyde condensation products, amino acids, ammonium salts and nitrates, and potassium salts may be used. The fertilizer granules may also contain micronutrients, such as iron, manganese, magnesium, boron, copper, zinc and the like, and mixtures thereof.

Suitable fertilizer granules for use as substrates herein include standard NPK type fertilizers which may include methylene urea nitrogen sources, phosphorus sources, single superphosphates, triple superphosphates, calcium phosphates, nitro phosphates, potassium phosphates, ammonium sulfate, ammonium phosphates, monoammonium phosphates (MAP), ammoniated superphosphates and the like and mixtures thereof. Further fertilizer granules suitable for use in any of the embodiments described herein include potassium sources such as muriate of potash, potassium sulfates, potassium phosphates, potassium hydroxides, potassium nitrates, potassium carbonates and bicarbonates, potassium magnesium sulfates, potassium chlorides, and the like and mixtures thereof.

Additional fertilizer granules suitable for use in any of the embodiments described herein include secondary nutrient sources such as elemental sulfur, calcium and magnesium salts including phosphates, oxides, sulfates, carbonates, chlorides, nitrates and the like and mixtures thereof. Still further fertilizer granules suitable for use in any of the embodiments described herein include micronutrient sources such as iron, manganese, copper, boron, zinc and molybdenum salts such as phosphates, oxides, sulfates, carbonates, chlorides, nitrates, borates, molybdates and the like and mixtures thereof as well as chelates of micro nutrients such as EDTA chelates and the like.

Representative materials that may be used as dry micronutrient substrates in any of the embodiments described herein include calcium nitrate, magnesium sulfate, magnesium nitrate, ferrous sulfate, ferrous nitrate, manganese sulfate, manganese nitrate, copper sulfate, copper nitrate, boric acid, sodium borate, zinc sulfate, zinc nitrate, sodium molybdate, ammonium molybdate and the like.

Another type of fertilizer granule that may be used in the compositions described herein is a controlled release fertilizer (CRF) granule such as a sulfur-coated fertilizer as exemplified by the fertilizers described in U.S. Pat. Nos. 3,295,950; 3,342,577; 3,576,613; 3,903,333; 4,042,366; 4,636,242; 4,857,098; 4,881,963; 5,219,465; 5,405,426; 5,599,374 and 6,338,746, each of which is hereby incorporated by reference.

Another type of CRF granule for use in any of the embodiments described herein is a polymer coated granule including a solvent applied polymer coating. The polymeric material applied to these granules may be either a thermosetting resin or a thermoplastic. Examples of solvent applied thermosetting resin coated fertilizers are disclosed in U.S. Pat. Nos. 3,223,518; 4,657,576 and 4,880,455, whereas examples based on thermoplastics can be found in U.S. Pat. No. 4,019,890. Each of these patents is hereby incorporated by reference.

Other polymer coated fertilizers that may be used in any of the embodiments described herein are described in U.S. Pat. Nos. 5,374,292; 5,547,486; 5,652,196; 5,858,094; 5,993,505; 6,139,597; 6,254,655; 6,312,493; 6,656,882; 6,787,234 and 6,987,082. Another polymer encapsulated fertilizer that may be used in any of the embodiments described herein is a latex coated granular fertilizer such as the fertilizers disclosed in U.S. Pat. No. 4,549,897 and U.S. Pat. No. 5,186,732. Each of these patents is hereby incorporated by reference.

The physical forms of the fertilizers to be employed in combination with the sulfonylurea herbicide and carrier to produce the compositions described herein include fertilizer granules. The fertilizer component can exist as a homogenous particle, produced by a molten urea reaction process, which contains methylene urea. The creation of a fertilizer using a molten urea reaction process is described in U.S. Pat. No. 5,102,440, which is hereby incorporated by reference.

The fertilizer component can alternatively exist as a physical blend, containing coated or uncoated urea. In one embodiment, fertilizer granule sizes ranges from about 1.0 to about 5.0 mm diameter. In one embodiment, fertilizer granule sizes ranges from about 0.6 to about 7.0 mm diameter. In one embodiment, particle length ranges from about 0.6 to about 10.0 mm.

In one embodiment, the chemical analysis for the fertilizer component to be included in the compositions described herein, when present, ranges from about 1 to about 50% by weight elemental nitrogen (N); about 0 to about 1% by weight phosphorous as P₂O₅; and about 1 to about 20% by weight potassium as K₂O. In one embodiment, the micronutrient content of the fertilizer ingredient ranges from about 1 to about 20,000 ppm (parts per million).

### Water-Absorbent Compound

In any of the embodiments described herein, the composition may include a water-absorbent compound. Examples of water-absorbent compounds include, but are not limited to magnesium sulfate, clay, specialty silica (e.g., SIPERNAT-17®), precipitate silica (e.g., HISIL®), calcium silicate, calcium sulfate, and combinations thereof. This compound may act as a scavenger to reduce the moisture content of the overall compound to a desired level. In one embodiment, the compound reduces the moisture content of the overall composition to a level of for example, less than 2.00% moisture, less than 1.75% moisture, less than 1.5% moisture, less than 1.25% moisture, or less than 1.00% moisture.

In some embodiments, the water-absorbent compound comprises at least 0.01%, at least 0.025%, at least 0.05%, at least 0.10%, at least 0.15%, at least 0.25%, at least 0.5%, at least 1.00%, at least 1.5%, at least 2.0%, at least 2.5%, at least 3.5%, at least 4.0%, at least 5.0%, at least 6.0%, at least 7.5%, at least 8.0%, at least 8.5%, at least 9.0%, at least 9.5%, or at least 10.0% by weight of the composition.

In any of the embodiments described herein, the water absorbent compound can be sprayed onto a composition comprising a substrate, sulfonylurea herbicide, and a carrier (e.g., a solvent or tackifier). In any of the embodiments described herein, the water absorbent compound can be included in the substrate prior to the coating or tacking of the sulfonylurea herbicide and carrier. In another embodiment, the water absorbent compound is impregnated into the substrate, and the substrate is then coated with the sulfonylurea herbicide and carrier. In one embodiment, the water absorbent compound is impregnated into the substrate, wherein the sulfonylurea herbicide and carrier are also impregnated into the substrate.

### Sulfonylurea Herbicides

The herbicidal compositions described herein comprise sulfonylurea herbicides, which generally have the structure of RSO₂NHC(O)NRR′. In any of the embodiments described herein, the sulfonylurea herbicide can include, but is not limited to, metsulfuron-methyl, chlorsulfuron, sulfometuron methyl, thifensulfuron methyl, halosulfuron methyl, triasulfuron, nicosulfuron, rimsulfuron, flazasulfuron, trifensulfuron methyl, primisulfuron, tribenuron, imazosulfuron, triasulfuron, sulfometuron, chlorimuron, amidosulfuron, azimsulfuron, bensulfuron, cinosulfuron, cyclosulfamuron, ethametsulfuron, ethoxysulfuron, flucetosulfuron, flupyrsulfuron, mesosulfuron, pyrazosulfuron, sulfosulfuron, foramsulfuron, metazosulfuron, orthosulfamuron, oxasulfuron, propyrisulfuron, trifloxysulfuron, and combinations thereof.

In some embodiments, the compositions described herein comprises a sulfonylurea herbicide that is 0.001-0.075% by weight of the composition. In any of the embodiments described herein, the sulfonylurea herbicide is 0.0020-0.0250% by weight of the composition.

In some embodiments, the composition comprises sulfonylurea particles less than 400 microns in diameter, less than 350 microns in diameter, less than 300 microns in diameter, less than 250 microns in diameter, less than 200 microns in diameter, less than 150 microns in diameter, or less than 100 microns in diameter. In one embodiment, the sulfonylurea herbicide has an average mean particle size of less than 80 microns in diameter.

In some embodiments, the sulfonylurea herbicide comprises metsfulfuron-methyl. Metsulfuron-methyl is a sulfonylurea herbicide having the chemical structure of 2-[[[[(4-Methoxy-6-methyl-1,3,5-triazin-2-yl)amino]carbonyl]amino]sulfonyl]benzoic acid methyl ester or methyl 2-(4-methoxy-6-methyl-1,3,5-triazin-2-ylcarbamoylsulfamoyl)benzoic acid. In some embodiments, the sulfonlylurea herbicide is a metsulfuron-methyl technical solution with a purity of greater than 85%, greater than 90%, greater than 95%, greater than 97%, or greater than 99% by weight.

### Carrier

The sulfonylurea herbicides described herein may be mixed with a carrier to form a coating. In some embodiments, the carrier is applied to a substrate (e.g., stabilizing compound and/or fertilizer) by coating or tacking onto the substrate, or is impregnated into the substrate. In some embodiments, the carrier is hydrophobic. In some embodiments, the carrier is a solvent or tackifier. The carrier may include, but is not limited to, polybutene, white mineral oil, mineral seal oil, hexylene glycol, methylated canola oil, oleylamine, or combinations thereof. In some embodiments, the carrier comprises at least 0.01%, at least 0.025%, at least 0.05%, at least 0.10%, at least 0.15%, at least 0.25%, at least 0.5%, at least 1.00%, at least 1.5%, at least 2.0%, at least 2.5%, at least 3.5%, at least 4.0%, at least 5.0%, at least 6.0%, at least 7.5%, at least 8.0%, at least 8.5%, at least 9.0%, at least 9.5%, or at least 10.0% by weight of the composition.

In any of the embodiments described herein, the sulfonylurea herbicide may be combined with a carrier (e.g., a solvent) to create a suspension, wherein the solvent comprises 50.0-99.9% by weight of the suspension composition, and the sulfonylurea herbicide comprises 0.01-50.0% by weight of the suspension composition.

In any of the embodiments described herein, the sulfonylurea herbicide may be combined with a carrier (e.g., a tackifier) to create a tackable composition, wherein the tackifier comprises 50.0-99.9% by weight of the tackable composition, and the sulfonylurea herbicide comprises 0.01-50.0% by weight of the tackable composition.

### Compositions

Compositions comprising the combination of any of the substrates, sulfonylurea herbicides, and carriers described herein are provided. These compositions may include any of the stabilizing compounds and/or water-absorbent compounds described herein.

In some embodiments, the composition comprises a substrate which is 1-95% by weight of the composition. In one embodiment, the substrate comprises a stabilizing compound, and is coated with a mixture of a sulfonylurea herbicide which is 0.001-0.075% by weight of the composition, and a carrier which is 0.01-10.0% by weight of the composition. In another embodiment, the composition further comprises a water-absorbent compound which may be 0.01-10.0% by weight of the composition.

In some embodiments, the composition comprises a substrate which is 1-95% by weight of the composition. In one embodiment, the substrate comprises a fertilizer, and is coated with a mixture of a sulfonylurea herbicide which is 0.001-0.075% by weight of the composition, and a carrier which is 0.01-10.0% by weight of the composition. In another embodiment, the composition further comprises a water-absorbent compound which may be 0.01-10.0% by weight of the composition.

In some embodiments, the composition comprises a substrate which is 1-95% by weight of the composition, and comprises a blend of a stabilizing compound and a granular fertilizer. In some embodiments, the substrate is coated with a mixture of a sulfonylurea herbicide which is 0.001-0.075% by weight of the composition and a carrier which is 0.01-10.0% by weight of the composition. In another embodiment, the composition may further comprise a water-absorbent compound which may be 0.01-10.0% by weight of the composition.

In any of the above embodiments, the composition comprises 1-95% by weight of a substrate, 0.0200-0.0250% by weight of a sulfonylurea herbicide (e.g., metsulfuron-methyl), 0.01-1.00% by weight of a solvent (e.g., polybutene, canola oil, etc.), 7.0-10.0% by weight of a stabilizing compound (e.g., peanut hulls, diatomaceous earth, cellulosic fibers such as BIODAC®, etc.), and, optionally, 0.01-0.20% by weight of a water-absorbent compound (e.g., magnesium sulfate, clay, specialty silica, precipitate silica, calcium silicate, calcium sulfate, etc.).

In one embodiment, the composition is as follows:

| Component | Weight (%) |
|---|---|
| Urea | 66.398 |
| Urea Formaldehyde | 7.329 |
| Potassium Chloride | 16.200 |
| BIODAC ® | 8.951 |
| Metsulfuron Methyl | 0.0225 |
| Polybutene | 0.700 |
| Magnesium Sulfate (anhydrous) | 0.1995 |

In one embodiment, the composition is as follows:

| Component | Weight (%) |
|---|---|
| BIODAC ® 10/30 | 97.479 |
| Metsulfuron Methyl | 0.03070 |
| Polybutene L-14 | 2.4903 |

### Stability

In some embodiments, the compositions described herein are surprisingly shelf-stable over extended periods of time and are not prone to degradation. For example, in any of the compositions described herein, the composition is stable. In some embodiments, the composition is stable, e.g., the composition may degrade less than 15%, less than 14%, less than 13%, less than 12%, less than 11%, less than 10%, less than 9%, less than 8.5%, less than 8%, less than 7.5%, less than 7%, less than 6.5%, less than 6%, less than 5.5%, less than 5%, less than 4.5%, less than 4%, less than 3.5%, less than 3%, less than 2.5%, less than 2%, less than 1.5%, or less than 1% over a period of at least five months, at least six months, at least seven months, at least eight months, at least nine months, at least ten months, at least eleven months, at least twelve months, at least fifteen months, at least eighteen months, at least twenty months, at least twenty-two months, or at least twenty-four months. Degradation is determined by measuring a sulfonylurea herbicide component at an initial time point (e.g., T₀), and then comparing the amount of the sulfonylurea herbicide in the composition at later time points (e.g., T₁, T₂, T₃) and calculating the amount of active lost over that time.

In some embodiments, the composition is stored in a temperature of no more than 50° C., no more than 45° C., no more than 40° C., no more than 35° C., no more than 25° C., or no more than 20° C.

In one embodiment, the composition is stored in a temperature of no more than 50° C., and is stable for a period of at least one month. In another embodiment, the composition is stored in a temperature of no more than 40° C., and is stable for a period of at least two months. In another embodiment, the composition is stored in a temperature of no more than 35° C., and is stable for a period of at least three months. In another embodiment, the composition is stored at room temperature and is stable for a period of at least three months, at least six months, at least nine months, at least twelve months, at least fifteen months, at least eighteen months, at least twenty-one months, or twenty-four months.

The compositions described herein can be contained in a bag or container for consumer use. In one embodiment, the composition is shelf-stable and can be stored for an extended period of time (e.g., a period of twenty-four months) with little degradation.

### Methods of Making

The compositions described herein can be made by various methods.

In some embodiments, a liquid suspension is formed by creating a generally heterogeneous mixture containing an internal phase (e.g., solid particles of a sulfonylurea herbicide) and an external phase (e.g., a hydrophobic solvent). The suspended particles will settle over time if left undisturbed. The internal phase may be dispersed throughout the external phase (fluid) through mechanical agitation, in some embodiments, with the use of stabilizing compounds (e.g., BIODAC®). In some embodiments, mixing technology may be used for liquid dispersion (e.g., high shear mixing). A blender or mixer may be filled with a substrate. In some embodiments, the blender or mixer may be a ribbon blender, paddle blender, plow blender, tumbling in-container blender, planetary blender, conical screw blender, orbital mixer, fluidized mixer, high intensity mixer, rotary drum mixer, double cone mixer, or twin shell blender mixer. In some embodiments, the liquid suspension is coated (e.g., sprayed, dipped, etc.) onto the substrate. The liquid suspension comprising sulfonylurea herbicide and a hydrophobic solvent may be sprayed onto a substrate while mixing and/or blending. In some embodiments, a water-absorbent compound is added into the mixer or blender after the liquid suspension is sprayed onto the substrate. The resulting mixture is additionally blended and mixed.

In some embodiments, the water-absorbent compound is added into the mixer prior to the spraying of the liquid suspension.

In some embodiments, the sulfonylurea herbicide is metsulfuron-methyl. In other embodiments, the metsulfuron-methyl is 1-15% by weight of the liquid suspension.

In one embodiment, the substrate comprises a stabilizing compound. In another embodiment, the substrate comprises a fertilizer. In another embodiment, the substrate comprises a stabilizing compound and a granular fertilizer, which are mixed prior to the application of the liquid suspension to the substrate. In another embodiment, the substrate comprising a stabilizing compound and a granular fertilizer is dried to a moisture content of less than 2%, 1.5%, or 1% prior to combination with the liquid suspension. In one embodiment, the granular fertilizer is dried prior to the combination with the stabilizing compound to create the substrate.

In another embodiment, the sulfonylurea compound, which is suspended in a hydrophobic solvent, is distributed substantially equally onto the substrate. In one embodiment, substantially equally means the sulfonylurea herbicide concentration can be analyzed and found to be at statistically similar concentrations from samples taken at different points within a production time frame or batch. It is advantageous to have a substantially equal distribution of the liquid suspension, as varying rates of herbicide across products may not be desired. For a consumer product, the composition of one compound as compared to another should be relatively similar to provide the same results to every customer. Therefore, a substantially equal distribution of the herbicidal component may be beneficial.

In one embodiment, the substrate comprises a stabilizing compound and a fertilizer. This substrate is then dried and cooled before the particle size is screened for preferred size.

In some embodiments, a tackable compound is created containing a stabilizing compound and sulfonylurea herbicide by dry blending the sulfonylurea herbicide and stabilizing compound until a uniform material is obtained. A tackifier may then be used to tack the tackable compound onto a substrate. In another embodiment, the water-absorbent compound is added after the tacking process described herein. The resulting compound is then blended.

### Methods of Using

Methods of using the compositions described herein are provided. In one embodiment, the present invention relates to a method for controlling weeds comprising applying any of the compositions described herein to an area in need thereof. In one embodiment, the present invention provides for a method of controlling weeds by applying any of the compositions described herein to a soil and/or lawn. In other embodiments, the area in need thereof, soil and/or lawn contains seeds and/or plants.

In one embodiment, the composition described herein is applied to a lawn. In another embodiment, the composition can be applied to a lawn comprising warm season grasses. In another embodiment, the composition can be applied to a lawn comprising Bermuda grass, St. Augustine grass, seashore paspalum, centipedegrass, buffalograss, seashore paspalum, zoysiagrass, Kentucky bluegrass, and/or fine fescue.

In another embodiment, the invention relates to a lawn to which any of the embodiments described herein has been applied. In one embodiment, the composition is present on the lawn in rate of 3.13 lb/1000 ft².

When applied, any of the compositions described herein control annual sowthistle, aster, black medic, broadleaf plantain, buckhorn plantain, California burclover, Carolina geranium, catsear, chicory, common chickweed, common groundsel, common mallow, common purslane, common yarrow, corn speedwell, creeping woodsorrel, crown vetch, cudweed, dandelion, dollarweed (pennywort), eclipta, English daisy, evening primrose, Florida betony, Florida pusley, ground ivy, hairy bittercress, henbit, hop clover, horseweed, khakiweed, lambsquaters, lawn burweed (spurweed), mouseear chickweed, mustard, parsley-piert, Pensacola bahiagrass, perennial ryegrass, pigweed, pineapple-weed, prostrate knotweed, punctureville, purple deadnettle, red clover, shepherd's-purse, spurge, white clover, wild carrot, wild garlic, wild violet, and yellow woodsorrel (oxalis). Any of the embodiments described herein can suppress Argentine bahiagrass, Canada thistle, field bindweed, and Virginia buttonweed. In any of the embodiments described herein, the composition can provide 2-month control of broadleaf plantain, buckhorn plantain, California burclover, dandelion, dollarweed (pennywort), and white clover. In one embodiment, the compositions of any of the embodiments described herein are applied to a lawn via conventional spreaders, including, but not limited to, drop spreaders, walk behind spreaders, cartridge spreaders, rotary spreaders, or broadcast spreaders.

The following specific examples are presented to further illustrate certain aspects of the present invention, and are not to be construed as limiting the present invention. In the following examples, all percentages and parts are by weight unless otherwise specified.

All examples follow the CIPAC (Collaborative International Pesticide Analytical Council) Methodology.

### EXAMPLES

### Example 1

### Stability Comparison of Metsulfuron-Methyl in a Polybutene Solution Over Time

Metsulfuron-methyl (MSM) was suspended in a liquid suspension of polybutene and stored in a glass jar for a period of eight weeks to monitor the amount of metsulfuron-methyl at room temperature, 35° C., and 50° C.

The formula for this experiment is as follows:

| Ingredient | Amount (%) |
|---|---|
| MSM Technical | 1.23-4.31 |
| Polybutene | 95.69-98.81 |

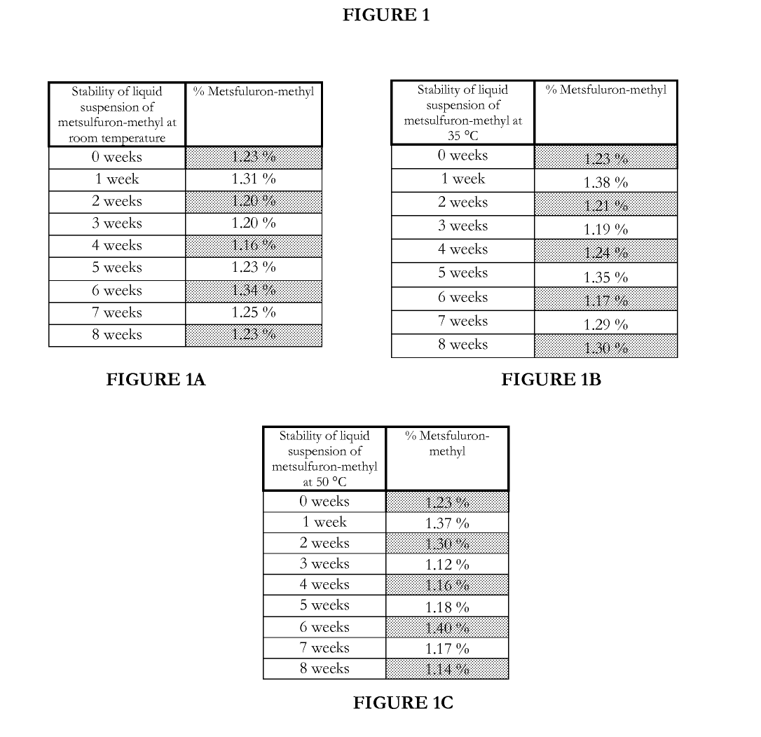

FIGS. 1A-1C demonstrate the stability of MSM within a liquid suspension containing 1.23% metsulfuron-methyl by weight over a period of 8 weeks at various temperatures. FIG. 1A demonstrates that the liquid suspension at room temperature did not have any reduction of the MSM. FIG. 1B demonstrates that the liquid suspension at 35° C. did not have any reduction of the MSM. FIG. 1C demonstrates that the liquid suspension at 50° C. had around only a 7.3% reduction of MSM, which is not a significant amount of degradation.

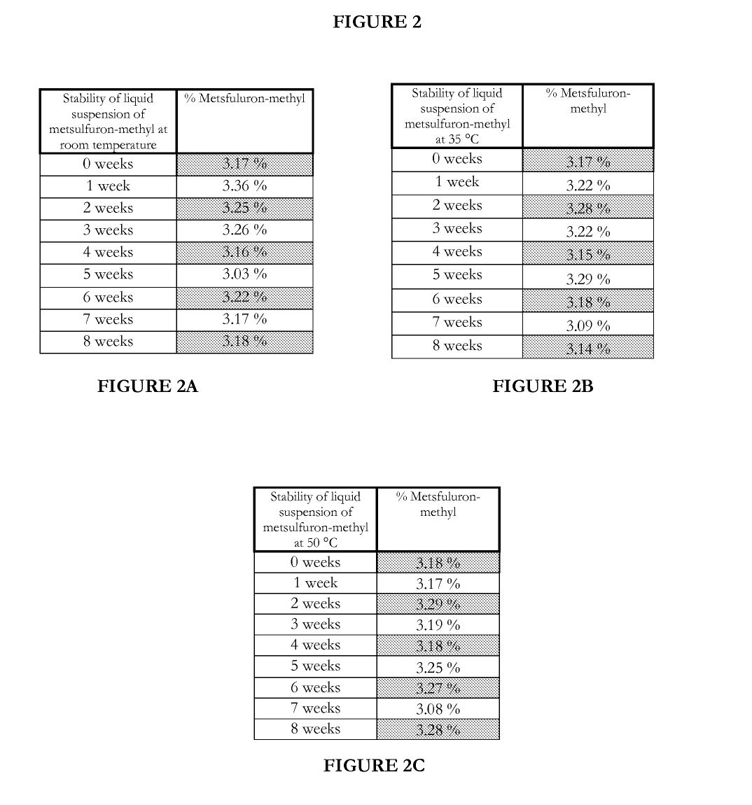

FIGS. 2A-2C demonstrate the stability of metsulfuron-methyl within a liquid suspension containing 3.17-3.18% metsulfuron-methyl by weight over a period of 8 weeks at various temperatures. FIG. 2A demonstrates that the liquid suspension at room temperature did not have any reduction of the MSM. FIG. 2B demonstrates that the liquid suspension at 35° C. had less than 1% reduction of MSM, which is not a significant amount of degradation. FIG. 2C demonstrates that the liquid suspension at 50° C. did not have any reduction of the MSM.

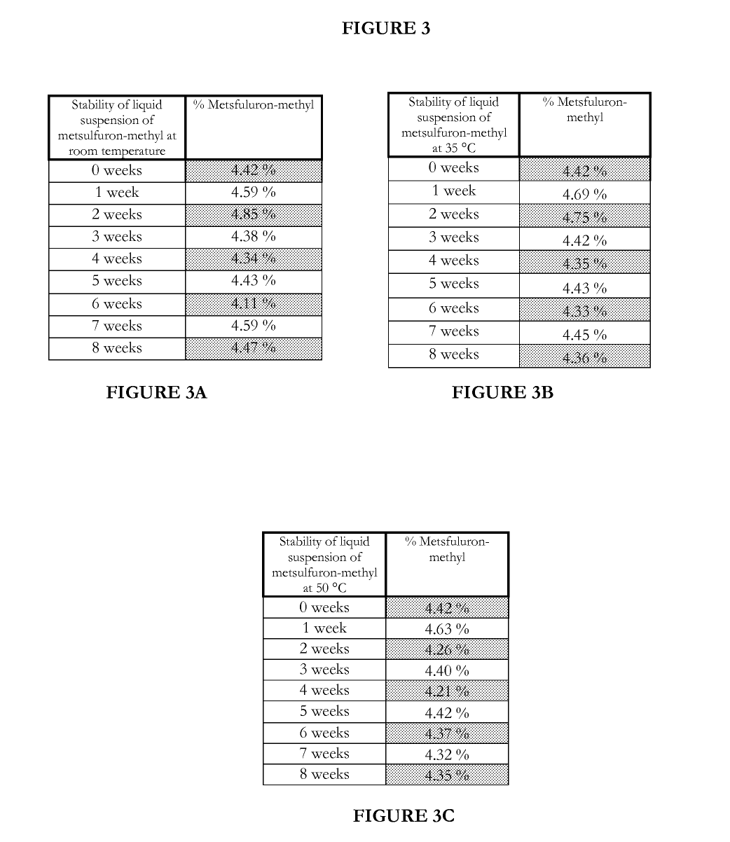

FIGS. 3A-3C demonstrate the stability of metsulfuron-methyl within a liquid suspension containing 4.42% metsulfuron-methyl by weight over a period of 8 weeks at various temperatures. FIG. 3A demonstrates that the liquid suspension at room temperature did not have any reduction of the MSM. FIG. 3B demonstrates that the liquid suspension at 35° C. had around a 1% reduction of MSM, which is not a significant amount of degradation. FIG. 3C demonstrates that the liquid suspension at 50° C. around a 1% reduction of MSM, which is not a significant amount of degradation.

This data shows that MSM in a liquid suspension of polybutene is stable at various temperatures for a period of eight weeks.

### Example 2

### Stability Comparison of Various Compositions with Changing Variables

MSM is prone to degradation. This example describes various components and conditions that were tested to determine which combination of components and conditions resulted in the least degradation of MSM.

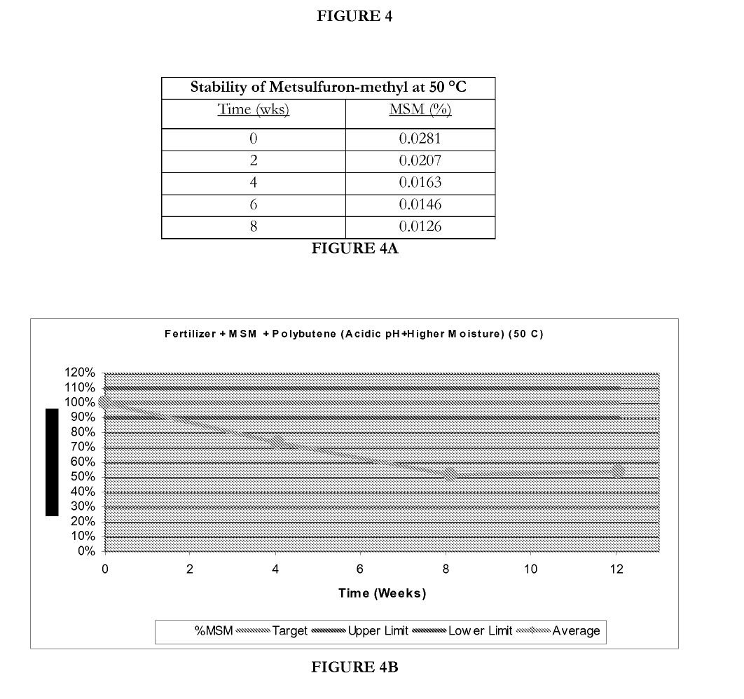

FIG. 4 shows the stability of a composition comprising a granular fertilizer, MSM, and polybutene. MSM was suspended in a liquid suspension of polybutene, and then sprayed onto a granular fertilizer. The formula for this experiment is shown in Table 1.

TABLE 1

| Ingredient | Amount (%) |
|---|---|
| Urea | 64.57 |
| K₂SO₄ | 16.20 |
| Ammonium sulfate | 16.04 |
| Monoammonium phosphate (MAP) | 2.25 |
| MSM Technical (97.7%) | 0.02200 |
| Polybutene L14 | 0.70000 |

Due to the moisture content and pH of the individual components and the environment during processing and formulation (e.g., high humidity atmosphere), the composition had an acidic pH and high moisture. Metsulfuron-methyl contained in the composition degrades by nearly 50% over a period of twelve weeks when stored at a temperature of 50° C.

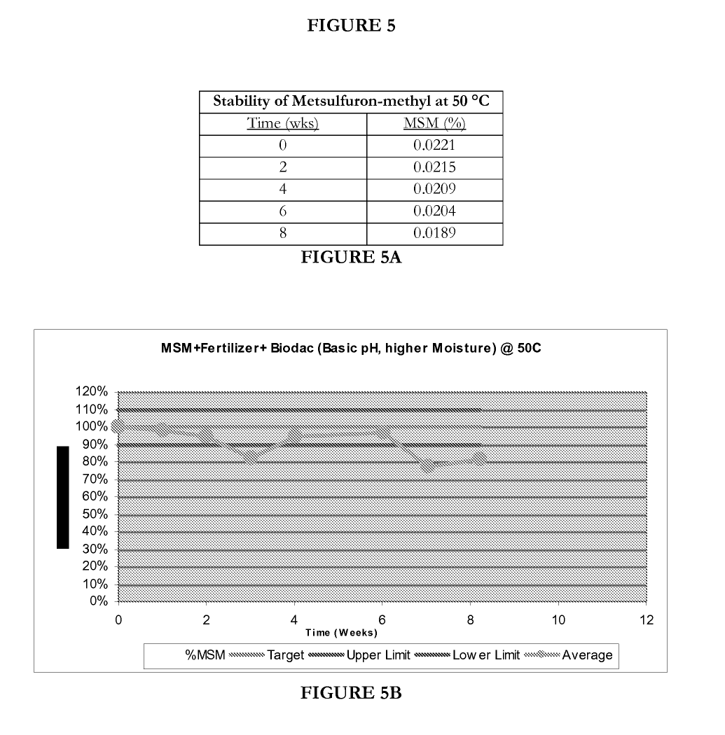

FIG. 5 demonstrates the stability of a composition comprising fertilizer, metsulfuron-methyl, polybutene, and BIODAC®. A granular fertilizer was blended with BIODAC® to produce a granular mixture. MSM was suspended in a liquid suspension of polybutene, and then sprayed onto the granular mixture of fertilizer and BIODAC®. The formula for this experiment is shown in Table 2.

TABLE 2

| Ingredient | Amount (%) |
|---|---|
| Urea | 73.26800 |
| KCl standard | 16.20000 |
| BIODAC ® 20/50 | 9.81000 |
| MSM Technical (97.7%) | 0.02200 |
| Polybutene L14 | 0.70000 |

Due to the moisture content and pH of the individual components and the environment during processing and formulation (e.g., high humidity atmosphere), the resulting composition had a basic pH and high moisture. The composition demonstrated MSM degradation of nearly 20% over a period of eight weeks when stored at a temperature of 50° C.

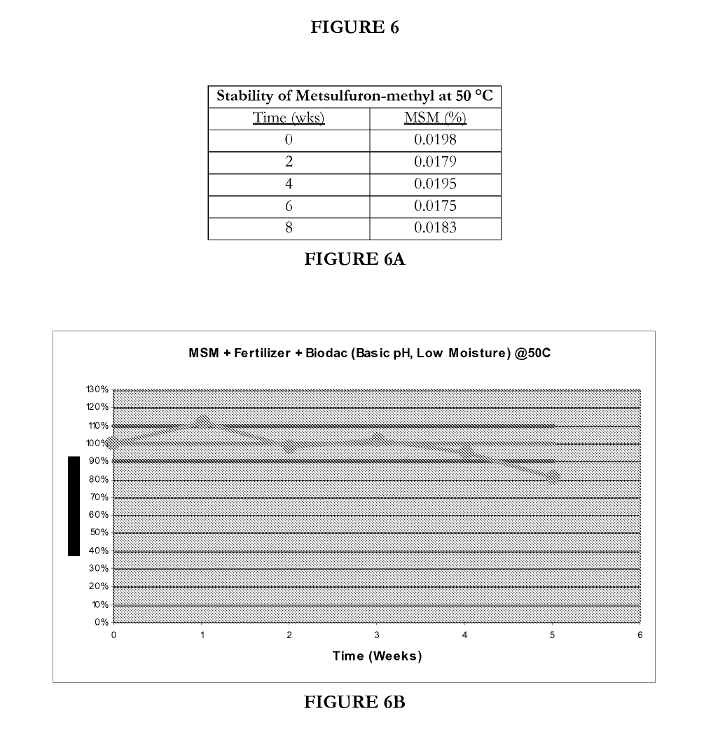

FIG. 6 shows the stability of a composition comprising fertilizer, MSM, polybutene, and BIODAC®. A granular fertilizer was blended with BIODAC® to produce a granular mixture. MSM was suspended in a liquid suspension of polybutene, and then sprayed onto the granular mixture of fertilizer and BIODAC®. The formula for this experiment is shown in Table 3.

TABLE 3

| Ingredient | Amount (%) |
|---|---|
| Urea | 73.268 |
| KCl standard | 16.200 |
| BIODAC ® 20/50 | 9.810 |
| MSM Technical (97.7%) | 0.022 |
| Polybutene L14 | 0.700 |

Due to the moisture content and pH of the individual components and the environment during processing and formulation, the resulting composition had a basic pH and low moisture. The composition demonstrated MSM degradation of 20% after a period of five weeks when stored at a temperature of 50° C.

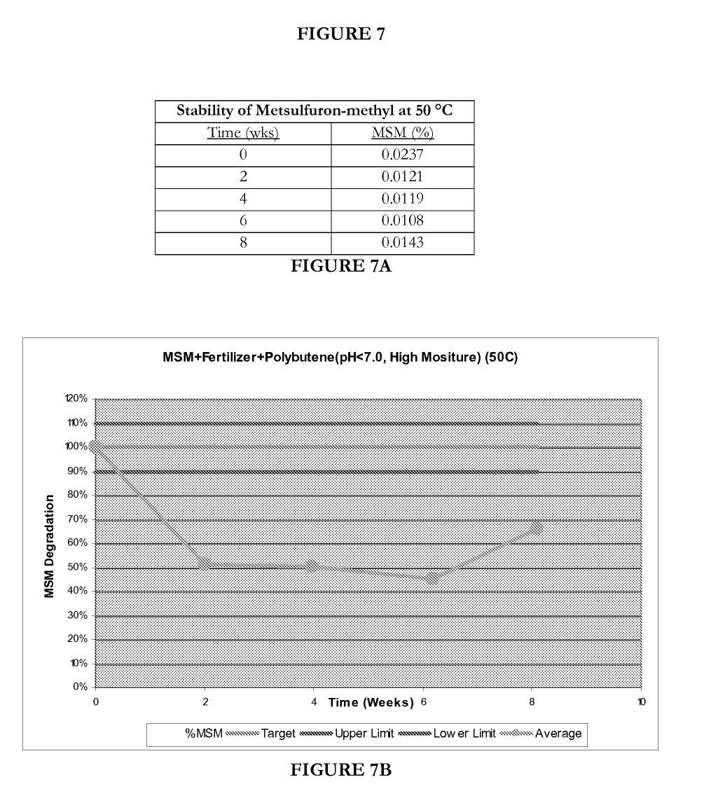

FIG. 7 shows the stability of a composition comprising MSM, fertilizer, and polybutene. MSM was suspended in a liquid suspension of polybutene, and then sprayed onto a granular fertilizer. The formula for this experiment is shown in Table 4.

TABLE 4

| Ingredient | Amount (%) |
|---|---|
| Urea | 65.506 |
| K₂SO₄ | 16.200 |
| Ammonium Sulfate | 17.572 |
| MSM Technical (97.7%) | 0.022 |
| Polybutene L14 | 0.700 |

Due to the moisture content and pH of the individual components and the environment during processing and formulation (e.g., high humidity atmosphere), the resulting composition had a pH<7.0 and high moisture. The composition demonstrated MSM degradation of anywhere between 30% and 50% over a period of eight weeks when stored at a temperature of 50° C.

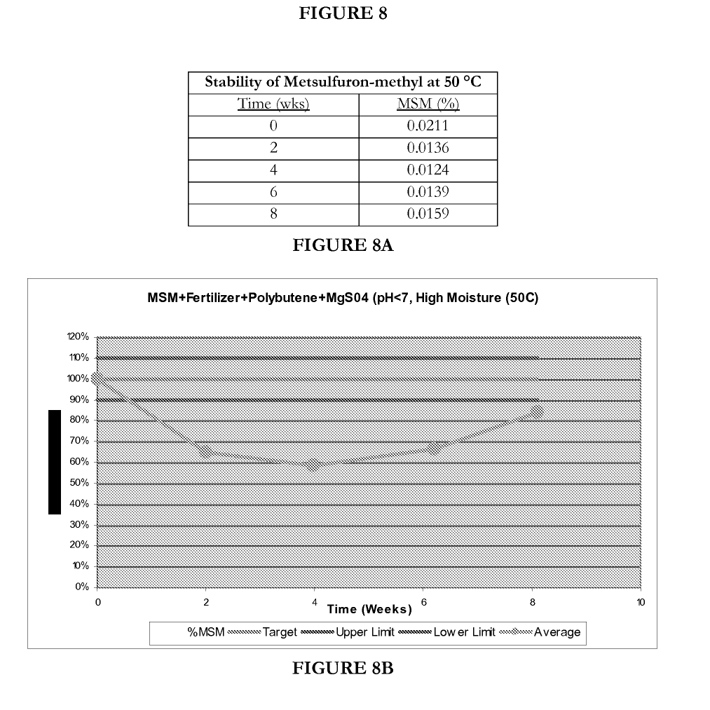

FIG. 8 shows the stability of a composition comprising fertilizer, MSM, polybutene, and MgSO₄. MSM was suspended in a liquid suspension of polybutene, and then sprayed onto a granular fertilizer. This compound was blended, and during the blending process, MgSO₄ was added to the mixture and additionally blended. The formula for this experiment is shown in Table 5.

TABLE 5

| Ingredient | Amount (%) |
|---|---|
| Urea | 65.838 |
| K₂SO₄ | 16.200 |
| Ammonium Sulfate | 17.040 |
| MSM Technical (97.7%) | 0.022 |
| Polybutene L14 | 0.700 |
| MgSO₄ | 0.200 |

Due to the moisture content and pH of the individual components and the environment during processing and formulation (e.g., high humidity atmosphere), the resulting composition had a pH<7.0 and high moisture. The composition demonstrated MSM degradation of anywhere between 20% and 40% over a period of eight weeks when stored at a temperature of 50° C.

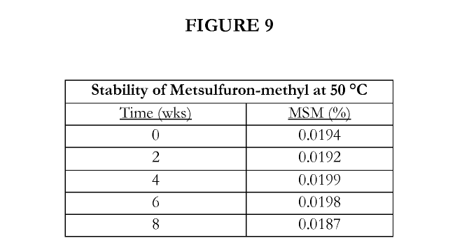

FIG. 9 shows the stability of a composition comprising fertilizer, MSM, BIODAC®, polybutene, and MgSO₄. A granular fertilizer and BIODAC® were blended to create a granular composition. MSM was suspended in a liquid suspension of polybutene, and then sprayed onto the granular composition. This compound was blended, and during the blending process, MgSO₄ was added to the mixture and additionally blended. The formula used is shown in Table 6.

TABLE 6

| Ingredient | Amount (%) |
|---|---|
| Urea | 73.26800 |
| KCl standard | 16.20000 |
| BIODAC ® 20/50 | 9.61000 |
| MSM Technical (97.7%) | 0.02200 |
| Polybutene L14 | 0.70000 |
| MgSO₄ | 0.20000 |

Due to the moisture content and pH of the individual components and the environment during processing and formulation, the resulting composition had a basic pH and low moisture. The composition demonstrated MSM degradation of less than 10% over a period of eight weeks when stored at a temperature of 50° C.

Compositions that created conditions of low moisture and high pH had the lowest degradation levels.

The composition depicted in FIGS. 6 and 9 contained the hydrophobic solvent but did not have a stabilizing compound. This resulted in metsulfuron-methyl degradation levels greater than 10%.

In some of the examples, the addition of a stabilizing compound to the composition resulted in a more stable formulation with less degradation. In some of the examples, the addition of a water absorbent compound also helped to reduce the moisture of the composition, resulting in a more stable composition.

### Example 3

A composition was created by suspending MSM Technical in polybutene. The composition was then sprayed onto BIODAC®. The formula is shown in Table 7.

TABLE 7

| Component | Weight (%) |
|---|---|
| BIODAC ® 10/30 | 97.479 |
| MSM Technical | 0.03070 |
| Polybutene L-14 | 2.4903 |

The composition was then observed for a period of a year at room temperature and the percentage of degradation was measured. The stability data is shown in Table 8.

TABLE 8

| Time | % Active | % Retained |
|---|---|---|
| Initial | 0.028 | |
| 3 Month | 0.0254 | 90.8 |
| 9 Month | 0.0262 | 93.7 |
| 1 Year | 0.0243 | 86.9 |

This demonstrates that a composition comprising a sulfonylurea herbicide (e.g., MSM), a substrate comprising a stabilizing compound (e.g., BIODAC®), and a carrier (e.g., polybutene) degraded less than 15% over a one year period of storage.

### Example 4

Approximately 3.73 grams of MSM technical was added to 23.8 grams of methylated canola oil and allowed to form a slurry with continuous agitation. This was then applied to 3.44 lbs of MURP fertilizer and allowed to mix for approximately 10 minutes. Table 9 shows the stability of the composition over a period of six weeks at various temperatures.

TABLE 9

| Description | MSM % | Rep. % | Average % | % Retained |
|---|---|---|---|---|
| Initial | 0.022 | 0.022 | 0.022 | |
| RT-3 Wk. | 0.0222 | 0.023 | 0.023 | 102.7 |
| 35° C. @ 3 Wk. | 0.0196 | 0.0195 | 0.020 | 88.9 |
| 50° C. @ 3 Wk. | 0.0114 | 0.0128 | 0.012 | 55.0 |
| RT @ 6 Wk. | 0.0212 | 0.0212 | 0.021 | 96.4 |
| 35° C. @ 6 Wk. | 0.016 | 0.0166 | 0.016 | 74.1 |
| 50° C. @ 6 Wk. | 0.009 | 0.0093 | 0.009 | 41.6 |

This experiment demonstrates that a composition comprising a sulfonylurea herbicide (e.g., MSM) and a carrier (e.g., methylated canola oil) degrades less than 10% when stored at room temperature over a period of six weeks.

### Example 5

MSM technical and oleylamine (OE) 15, were applied to POLY S® fertilizer to determine if the composition has long-term stability. 3.73 grams of MSM technical was added to 23.8 grams of oleylamine (OE) 15 and allowed to stir. The MSM technical dissolved into solution. This was then applied to 3.44 lbs of the POLY S® fertilizer and allowed to mix for 10 minutes. Table 10 demonstrates the stability over a period of six weeks at various temperatures.

TABLE 10

| Description | MSM % | Rep. % | Average % | % Retained |
|---|---|---|---|---|
| Initial | 0.020 | 0.020 | 0.020 | |
| RT @ 3 Wk. | 0.0196 | 0.0199 | 0.020 | 98.8 |
| 35° C. @ 3 Wk. | 0.0185 | 0.0179 | 0.018 | 91.0 |
| 50° C. @ 3 Wk. | 0.0126 | 0.0132 | 0.013 | 64.5 |
| RT-6 Wk. | 0.0184 | 0.0187 | 0.019 | 92.8 |
| 35° C. @ 6 Wk. | 0.0162 | 0.0161 | 0.016 | 80.8 |
| 50° C. @ 6 Wk. | 0.0072 | 0.0069 | 0.007 | 35.3 |

This experiment demonstrates that a composition comprising a sulfonylurea herbicide (e.g., MSM), a fertilizer, and a carrier (e.g., oleyamine) degrades less than 20% over a period of six weeks when stored at room temperature and 35° C.

### Example 6

18 grams of Diatomaceous Earth was mixed with 2 grams of MSM technical to form approximately 10% intermediate. All intermediates were made in 4 oz jars and were put in a small table physical blend mixer with rubber gloves to mix for an undetermined amount of time. Intermediates were mixed in table top mixers for approximately 3 hours. Samples were taken at initial formulation, four weeks, and twelve weeks in conditions of room temperature, 35° C., and 50° C. Table 11 demonstrates the stability of the composition over a period of 12 weeks at various temperatures.

TABLE 11

| Description | MSM % | Rep. % | Average % | % Retained |
|---|---|---|---|---|
| Initial | 10.2 | 10.2 | 10.20 | |
| RT-4 Wk. | 9.83 | 9.93 | 9.88 | 96.9 |
| 35° C. @ 4 Wk. | 9.71 | 9.99 | 9.85 | 96.6 |
| 50° C. @ 4 Wk. | 9.48 | 9.59 | 9.54 | 93.5 |
| RT° C. @ 12 Wk. | 10.00 | 9.86 | 9.93 | 97.4 |
| 35° C. @ 12 Wk. | 10.20 | 10.20 | 10.20 | 100.0 |
| 50° C. @ 12 Wk. | 9.72 | 9.80 | 9.76 | 95.7 |

This experiment demonstrates that compositions comprising a sulfonylurea herbicide (e.g., MSM) and a carrier (e.g., diatomaceous earth) degrade less than 10% when stored at room temperature, 35° C., and 50° C. for a period of at least twelve weeks.

### Example 7

36 grams of sodium carbonate was mixed with 4 grams of MSM technical to form approximately 10% intermediate. All intermediates were made in 4 oz. jars and were put in a small table physical blend mixer with rubber gloves to mix. Intermediates were mixed in table top mixers for approximately 3 hours. Samples were taken at initial formulation, four weeks, and twelve weeks in conditions of room temperature, 35° C., and 50° C. Table 12 demonstrates the stability of the composition over a period of 12 weeks at various temperatures.

TABLE 12

| Description | MSM % | Rep. % | Average % | % Retained |
|---|---|---|---|---|
| Initial | 9.7 | 10.1 | 9.90 | |
| RT-4 Wk. | 9.48 | 9.46 | 9.47 | 95.7 |
| 35° C.-4 Wk. | 8.92 | 9.81 | 9.37 | 94.6 |
| 50° C.-4 Wk. | 9.32 | 9.92 | 9.62 | 97.2 |
| RT-12 Wk. | 9.78 | 9.93 | 9.86 | 99.5 |
| 35° C.-12 Wk. | 10.00 | 9.96 | 9.98 | 100.8 |
| 50° C.-12 Wk. | 8.96 | 9.23 | 9.10 | 91.9 |

This experiment demonstrates that compositions comprising a sulfonylurea herbicide (e.g., MSM) and a stabilizing compound (e.g., sodium carbonate) degrades less than 10% when stored at room temperature, 35° C., and 50° C. for a period of at least twelve weeks.

### Example 8

36 grams of sodium bicarbonate was mixed with 4 grams of MSM technical to form approximately. 10% intermediate. All intermediates were made in 4 oz jars and were put in a small table physical blend mixer with rubber gloves to mix. Intermediates were mixed in table top mixers for approximately 3 hours. Samples were taken at initial formulation, four weeks, and twelve weeks in conditions of room temperature, 35° C., and 50° C. Table 13 demonstrates the stability of the composition over a period of 12 weeks at various temperatures.

TABLE 13

| Description | MSM % | Rep. % | Average % | % Retained |
|---|---|---|---|---|
| Initial | 10.5 | 10.0 | 10.25 | |
| RT-4 Wk. | 9.73 | 9.34 | 9.54 | 93.0 |
| 35° C.-4 Wk. | 9.90 | 9.83 | 9.87 | 96.2 |
| 50° C.-4 Wk. | 8.45 | 8.75 | 8.60 | 83.9 |
| RT-12 Wk. | 9.84 | 9.94 | 9.89 | 96.5 |
| 35° C.-12 Wk. | 9.61 | 9.76 | 9.69 | 94.5 |
| 50° C.-12 Wk. | 9.23 | 9.53 | 9.38 | 91.5 |

This experiment demonstrates that compositions comprising a sulfonylurea herbicide (e.g., MSM) and a stabilizing compound (e.g., sodium bicarbonate) degrade less than 10% when stored at room temperature and 35° C. for a period of twelve weeks, and degraded less than 20% when stored at 50° C. for a period of twelve weeks.

### Example 9

Stability data of the composition described above in Table 6 was collected over a period of time. A granular fertilizer and BIODAC® were blended to create a granular composition. MSM was suspended in a liquid suspension of polybutene, and then sprayed onto the granular composition. This composition was blended, and during the blending process, MgSO₄ was added to the mixture and additionally blended.

The composition was then tested in an accelerated storage stability study conducted in accordance with the CIPAC procedure for Accelerated Storage (MT 46.3) as provided in CIPAC Handbook Volume J, dated 2000, to determine their chemical and physical stability. The objective of this testing was to simulate the normal long-term ageing of a granular formulation by heating. The accelerated storage study provides an indication of the performance after storage over an extended period of time (up to at least about 2 years) that can be expected of the tested products.

As noted above, the time/temperature protocol employed in this testing was in accordance with the CIPAC procedure for Accelerated Storage (MT 46.3). CIPAC's test regimen dictates that 50° C. for 4 weeks and 35° C. for 12 weeks is equivalent to 2 years stability. See CIPAC MT 46.3.

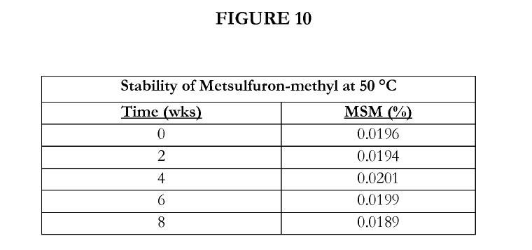

FIGS. 10-13 show the storage results of the experimental composition at various temperatures over a period of 8-52 weeks.

FIG. 10 shows that the experimental composition was stable (less than 10% degradation) over a period of 8 weeks at 50° C.

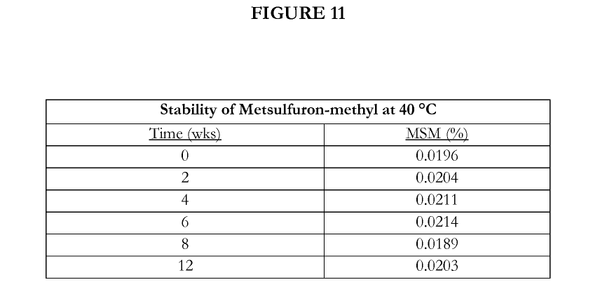

FIG. 11 shows that the experimental composition was stable over a period of 12 weeks at 40° C.

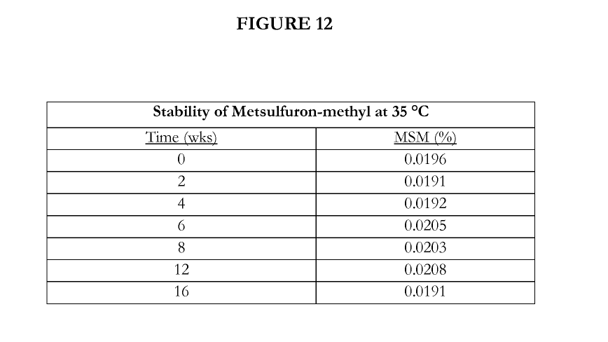

FIG. 12 shows that the experimental composition was stable over a period of 16 weeks at 35° C.

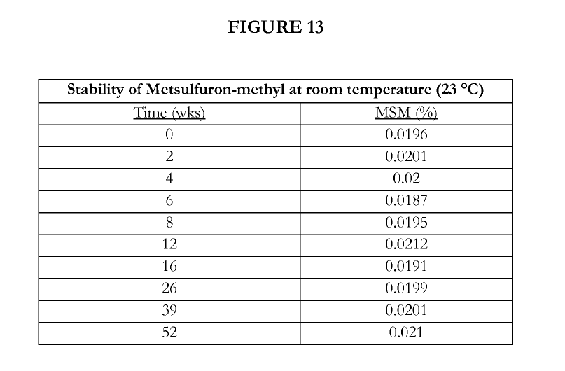

FIG. 13 shows that the experimental composition was stable over a period of 52 weeks at room temperature (23° C.).

These results show that a composition comprising a substrate coated with a sulfonylurea herbicide and a carrier is stable for at least 52 weeks.

1. A composition comprising a substrate, a sulfonylurea herbicide and a carrier.

2. The composition of claim 1, wherein the carrier comprises polybutene, white mineral oil, mineral seal oil, hexylene glycol, or combinations thereof.

3. The composition of claim 1 or 2, wherein the carrier comprises 0.01-10.00% by weight of the composition.

4. The composition of any of claims 1-3, wherein the substrate comprises a stabilizing compound.

5. The composition of claim 4, wherein the stabilizing compound comprises cellulose fiber.

6. The composition of claim 5, wherein the cellulose fiber comprises BIODAC®.

7. The composition of any of the above claims, wherein the substrate comprises a fertilizer.

8. The composition of claim 7, wherein the fertilizer is methylene urea, coated urea, uncoated urea, or combinations thereof.

9. The composition of any of claims 1-8, wherein the sulfonylurea herbicide comprises metsulfuron-methyl.

10. The composition of any of claims 1-9, wherein the composition has less than 10% degradation of metsulfuron-methyl over a period of 9 months.

11. The composition of any of claims 1-9, wherein the composition has less than 10% degradation when stored at a temperature of 50° C. or less for one month.

12. The composition of any of claims 1-9, wherein the composition has less than 10% degradation when stored at a temperature of 40° C. or less for two months.

13. The composition of any of claims 1-9, wherein the composition has less than 10% degradation when stored at a temperature of 35° C. or less for three months.

14. The composition of any of claims 1-9, wherein the composition has less than 10% degradation when stored at room temperature or less for 24 months.

15. The composition of any of claims 1-14, wherein the composition has a pH range of 7.0-10.0.

16. The composition of any of claims 1-15, further comprising a water-absorbent component.

17. The composition of claim 16, wherein the water-absorbent component is magnesium sulfate, clay, specialty silica, precipitate silica, calcium silicate, calcium sulfate, or combinations thereof.

18. The composition of claim 17, wherein the specialty silica comprises SIPERNAT D-17®.

19. The composition of claim 17, wherein the precipitate silica comprises HISIL®.

20. The composition of claims 16-19, wherein the water-absorbent component comprises 0.01-10.0% by weight of the compound.

21. The composition of any of claims 1-20, wherein the composition has a moisture level of 0-2%.

22. The composition of any of claims 1-21, wherein the substrate is coated with the sulfonylurea herbicide and the carrier.

23. The composition of claim 7, wherein the fertilizer is coated with the sulfonylurea herbicide and the carrier.

24. The composition of claim 23, wherein the substrate further comprises a stabilizing compound.

25. The composition of claim 24, wherein the stabilizing compound is uncoated by the sulfonylurea herbicide and the carrier.

26. A container or bag comprising the composition of any one of claims 1-25.

27. A method of making an herbicidal composition comprising suspending a sulfonylurea herbicide in a carrier to obtain a liquid suspension and spraying the liquid suspension onto a substrate, wherein the carrier is a solvent.

28. The method of claim 27, wherein the substrate comprises a stabilizing compound.

29. The method of claim 28, wherein the stabilizing compound comprises a cellulose fiber.

30. The method of claim 29, wherein the cellulose fiber comprises BIODAC®.

31. The method of any of claims 27-30, wherein the substrate further comprises a granular fertilizer.

32. The method of claim 31, wherein the granular fertilizer comprises methylene urea, coated urea, uncoated urea, or combinations thereof.

33. The method of any of claims 27-32, wherein the sulfonylurea herbicide is metsulfuron-methyl.

34. The method of any of claims 27-33, wherein the solvent comprises polybutene, white mineral oil, mineral seal oil, hexylene glycol, or combinations thereof.

35. The method of any of claims 27-34, wherein the carrier comprises 0.01-10.00% by weight of the composition.

36. The method of any of claims 27-35, further comprising adding a water-absorbent compound after spraying the liquid suspension onto the substrate or adding a water-absorbent compound before spraying the liquid suspension onto the substrate.

37. The method of claim 36, wherein the water-absorbent compound comprises magnesium sulfate, clay, specialty silica, precipitate silica, calcium silicate, calcium sulfate, or combinations thereof.

38. The method of claim 36 or 37, wherein the water-absorbent compound comprises 0.01-10.0% by weight of the compound.

39. The method of any of claims 27-38, wherein the substrate is dried to a moisture content of less than 2%.

40. The method of any of claims 27-39, wherein the herbicidal composition has a moisture level of 0-2%.

41. The method of any of claims 27-40, wherein the substrate has a pH of 7.0-10.0.

42. The method of any of claims 27-41, wherein the sulfonylurea herbicide suspended in a carrier is distributed substantially equally onto the substrate.

43. A composition comprising a substrate comprising a stabilizing compound, wherein the substrate is coated with a sulfonylurea herbicide and a hydrophobic solvent, prepared by a process comprising the steps of:
(a) suspending the sulfonylurea herbicide in a hydrophobic solvent; and
(b) spraying the compound of (a) onto the substrate.

44. The composition prepared by the process of claim 43, the process further comprising the step of adding a water-absorbent compound after the compound of (a) has been sprayed onto the substrate.

45. The composition prepared by the process of claim 43, the process further comprising the step of adding a water-absorbent compound to the substrate before the compound of (a) has been sprayed onto the substrate.

46. A composition comprising a substrate comprising a fertilizer, wherein the substrate is coated with a sulfonylurea herbicide and a hydrophobic solvent, prepared by a process comprising the steps of:
(a) suspending the sulfonylurea herbicide in a hydrophobic solvent; and
(b) spraying the compound of (a) onto the substrate.

47. The composition prepared by the process of claim 46, the process further comprising the step of adding a water-absorbent compound after the compound of (a) has been sprayed onto the substrate.

48. The composition prepared by the process of claim 46, the process further comprising the step of adding a water-absorbent compound to the substrate before the compound of (a) has been sprayed onto the substrate.

49. A composition comprising a substrate comprising a fertilizer and a stabilizing compound, wherein the substrate is coated with a sulfonylurea herbicide and a hydrophobic solvent, prepared by a process comprising the steps of:
(a) suspending the sulfonylurea herbicide in a hydrophobic solvent;
(b) mixing and/or blending the fertilizer and stabilizing compound to create a substrate;
and (c) spraying the compound of (a) onto the substrate of (b).

50. The composition prepared by the process of claim 49, the process further comprising the step of adding a water-absorbent compound after the compound of (a) has been sprayed onto the substrate.

51. The composition prepared by the process of claim 49, the process further comprising the step of adding a water-absorbent compound to the substrate before the compound of (a) has been sprayed onto the substrate.

52. The composition prepared by the process of any of claims 45-51, the process further comprising the step of drying the fertilizer prior to the creation of the substrate.

53. The composition prepared by the process of any of claims 45-51, the process further comprising the step of drying the fertilizer after the creation of the substrate.

54. A method for treating a lawn, comprising applying the composition of any of claims 1-25 to the lawn.

55. A method for treating a lawn, comprising applying the composition of any of claims 43-53 to the lawn.

56. The method of any claim 54 or 55, wherein the composition is contained in a bag and then applied to the lawn.

57. A lawn treated with the composition of any of claims 1-25.

58. The lawn of claim 57, comprising 3.13 lb of said composition per 1000 square feet of lawn.

59. A composition comprising: fertilizer, cellulose fibers, metsulfuron-methyl, and polybutene.

60. The composition of claim 59, wherein the cellulose fibers are BIODAC®.

61. The composition of claim 60, further comprising magnesium sulfate.

62. A composition comprising: (1) fertilizer in an amount of 85-95%, (2) BIODAC® in an amount of 8.8-9.8%, (3) metsulfuron-methyl in an amount of 0.0200-0.0230%, (4) polybutene in an amount of 0.700%, and (5) magnesium sulfate in an amount of 0.1900-0.2200%.

63. A composition comprising cellulose fibers, metsulfuron-methyl, and polybutene.

64. The composition of claim 63, wherein the cellulose fibers are BIODAC®.

65. The composition of claim 64, further comprising magnesium sulfate.

66. A composition comprising: (1) BIODAC® in an amount of 97.0-98.0%, (2) metsulfuron-methyl in an amount of 0.0300-0.0310%, and (3) polybutene in an amount of 2.400-2.500%.
